(19) United States
(12) Patent Application Publication
(10) Pub. No.: US 2017/0247586 A1
(43) Pub. Date: Aug. 31, 2017

(54) THERMALLY CURABLE SEALANT COMPOSITION AND THE USE THEREOF

(71) Applicant: Henkel AG & Co, KGaA, Duesseldorf (DE)

(72) Inventors: Jing Zhou, Shanghai (CN); BaoShan Gao, Shanghai (CN)

(21) Appl. No.: 15/593,530

(22) Filed: May 12, 2017

Related U.S. Application Data
(63) Continuation of application No. PCT/CN2014/090969, filed on Nov. 13, 2014.

(51) Int. Cl. C09J 163/00; C08L 63/00; G02F 1/1339; B32B 37/06; G02F 1/1341; C09J 11/04; B32B 37/12

(52) U.S. Cl. CPC C09J 163/00; C09J 11/04; C08L 63/00; B32B 37/12; B32B 37/06; G02F 1/1341; G02F 1/1339; C08K 3/36

(57) ABSTRACT

The present invention relates to a thermally curable sealant composition for sealing liquid crystal by means of one-drop-filling process, the cured product thereof and the manufacturing method of liquid crystal by using the same.

### TECHNICAL FIELD

The present invention generally relates to the field of a thermally curable sealant composition used for liquid crystal display devices. In particular, the present invention relates to a thermally curable sealant composition for sealing liquid crystal by means of one-drop-filling (ODF) process, the cured product thereof and the manufacturing method of liquid crystal by using the same.

### BACKGROUND

Liquid crystal display (LCD) panels having the characteristics of being light-weight and high-definition have been widely used as display panels for a variety of apparatuses including cell phones and TVs. Conventionally, the process for producing a LCD panel is called “vacuum-injection” process, which comprises applying a heat-curable sealant composition on a glass substrate with electrode, joining opposite facing glass substrates to each other, heat pressing and curing the resultant to form a cell, injecting the liquid crystal into the cell under vacuum, and then sealing the inlet after injection.

However, due to the increasing demand of LCD panels including small size for cell phones and large size for TVs in past few years, it was noticed that the conventional vacuum-injecting process is very time-consuming, which is a disadvantage for mass production, wherein short process times are required in order to improve the productivity.

The one-drop-filling (ODF) process has been proposed as a method for solving above mentioned problems. It comprises steps of 1) applying a sealant on a substrate having an electrode pattern and an alignment film under vacuum condition, 2) dropping liquid crystal on the substrate having the sealant applied thereon, 3) joining opposite facing substrates to each other under vacuum, and 4) subsequently releasing the vacuum and performing ultraviolet (UV) irradiation or UV and heat to cure the sealant, and thereby produce a LCD cell.

The sealants used in the ODF process are normally UV curable type or UV and heat curable type, as disclosed in e.g. JP 2001133794 A and JP 200623580 A. The UV curable type uses a UV-curable acryl-based resin as the main ingredient, while a UV and heat curable type normally uses partially acrylated or partially methacrylated epoxy resin as the main ingredient. While using the UV and heat curable type sealant, the UV-irradiation is performed in the first step to allow rapid fixing of the substrates, and subsequent heat-curing to complete the curing of the sealant. This type of sealant is considered to provide higher reliability than UV curable type, therefore, it has been the main manufacturing method for LCD panels in recent years.

However, normally on the glass substrate having an electrode pattern, there is complex metal wiring, which has overlap with the sealant pattern, and this results in some shadow area. This can cause an issue for UV and heat process—in shadow area the uncured sealant composition will contaminate the liquid crystal during post heat cure process, which causes decrease in display quality of the LCD. In the development of LCD with slim border (or narrow bezel) design, a narrow width of seal is used, which creates more challenge in the shadow area, wherein the sealant needs to provide good curability, high adhesion strength and reliability.

Another issue of UV light curing process is the damage of UV light to the liquid crystal and alignment film. Especially, the damage for the UV sensitive type liquid crystal like PSVA (polymer stabilized vertical alignment) liquid crystal, as described in Switching of polymer-stabilized vertical alignment liquid crystal cell, Chi-Yen Huang, Wen-Yi Jhuang, and Chia-Ting Hsieh, Optics Express, Vol. 16, Issue 6, pp. 3859-3864 (2008). Normally, a shadow mask is used to protect liquid crystal from UV light in production process, however there still remains reduction in yielding rate. Due to the increase of glass substrate size, the running cost of the UV irradiation apparatus increases and this is becoming an issue as well.

A heat curable sealant for sealing liquid crystal by ODF process, while the use of UV irradiation apparatus is not required, is assumed to resolve above-mentioned issues like good curability in shadow area and no damage caused by UV light to the liquid crystal and alignment film.

There are several proposals for the thermally sealant composition for sealing liquid crystal by ODF process. For example, JP 3955038 B2 proposes a heat curable sealant composition for the liquid crystal display containing 3-40 weight part of thermal curing agent with respect to 100 part by weight of curable resin having 3.5×10⁻³ or more hydrogen bonding functional groups and two or more (meth)acrylic groups in a molecule. Allegedly, this composition reduces liquid crystal contamination. However, in ODF process with heat-only cure, the liquid crystal cell can be easily broken and result in liquid crystal leak out because of the thermal expansion of liquid crystal under heat and sealant viscosity drop upon increased temperature. Furthermore, the sealant composition can easily migrate to the liquid crystal when viscosity drops to a lower level, and therefore, cause contamination to the liquid crystal.

JP 3976749 B2 discloses a curable sealant composition as a sealant for liquid crystal display. The composition contains acrylic copolymer particles or the sugar compound derivative particles as gelling agent, which can help preventing from sealant distortion or broken during heat-only cure process. The gelling agent has the function of decreasing the flowability when it gels at higher temperature, however it cannot accelerate the hardening process. A fast cure sealant composition is more crucial to guarantee the fast fixing of sealant shape and reduce contamination from the resin component. Nevertheless, the compositions that were mentioned in patents for heat-only curing ODF process are mainly based on the (meth)acrylic epoxy resin with hydrazide compound, which do not cure fast enough to fix the sealant shape and reduce contamination, as disclosed in JP2011150181 A.

Therefore, there is still a need to develop thermally curable sealant composition for sealing liquid crystal by ODF process, which possesses fast curing speed and good viscosity stability, and results in a cured product with excellent adhesion strength and high reliability.

### SUMMARY OF THE INVENTION

It is one aspect of the present invention to provide a thermally curable sealant composition, comprising: (a) a cyanate ester resin, (b) an epoxy resin, (c) a latent curing agent, and (d) a gelling agent which comprises one or more core particles consisting of a resin having a glass transition temperature of lower than −10° C., and one or more shell layers consisting of a resin having a glass transition temperature of 50-150° C. formed on the surface of the core particle.

According to another aspect, the present invention provides a cured product of the sealant composition according to the present invention.

According to yet another aspect, the present invention provides a method for manufacturing a liquid crystal display having a liquid crystal layer between a first substrate and a second substrate, the method comprising the steps:

(a) applying the sealant composition according to the present invention on a sealing region at periphery of a surface of the first substrate;

(b) dropping liquid crystal on a central area encircled by the sealing region of the surface of the first substrate and obtaining a liquid crystal layer;

(c) overlaying the second substrate on the first substrate; and

(d) performing fixation and curing by heating the sealant composition at from 80 to 130° C. for 30 min to 3 h.

According to yet another aspect, the present invention provides the use of the sealant composition or the cured product according to the present invention in the manufacturing of liquid crystal display devices, particularly by ODF process.

Other features and aspects of the subject matter are set forth in detail below.

### BRIEF DESCRIPTION OF THE DRAWINGS

FIG. 1 illustrates the specimen for sealant strength test used for the examples.

### DETAILED DESCRIPTION

It is to be understood by one of ordinary skill in the art that the present discussion is a description of exemplary embodiments only, and is not intended as limiting the broader aspects of the present invention.

The improved thermally curable sealant composition according to one aspect of the present invention comprises: (a) a cyanate ester resin, (b) an epoxy resin, (c) a latent curing agent, and (d) a gelling agent, which comprises one or more core particles consisting of a resin having a glass transition temperature of lower than −10° C., and one or more shell layers consisting of a resin having a glass transition temperature from 50 to 150° C. formed on the surface of the core particle.

As mentioned above, in thermally curing ODF process, the sealant viscosity drops upon temperature increasing, and this is the root cause for the breaking and contamination of liquid crystal cell. Therefore, it is necessary to develop a fast curing and/or fast gelling sealant composition, which can provide the fast fixing of sealant shape and thus avoid the contamination of liquid crystal cell from the resin components. Surprisingly, the applicant has found that the sealant compositions according to the present invention have fast cure speed with good viscosity stability, and the cured products thereof have excellent adhesion strength and high reliability. These features enable their suitable use for sealing liquid crystal by one-drop-filling method that does not require ultraviolet irradiation process.

### The Cyanate Ester Resin

Cyanate ester resins suitable for use in the present invention comprise cyanate ester compounds, either monomers or oligomers each having one or more —OCN functional groups, and typically having a cyanate equivalent weight from 50 to 500, preferably from 50 to 250. The weight average molecular weight of the cyanate ester resins are typically from 150 to 2000. If the molecular weight is too low, the cyanate ester resin may have a crystalline structure which is difficult to dissolve. If the molecular weight is too high, the compatibility of the cyanate ester resin with other resins may be poor.

In one embodiment, the cyanate ester resin useful in the present invention is selected from a polyfunctional monomeric cyanate ester, a polyfunctional polymeric cyanate ester, and combinations thereof.

The polyfunctional monomeric cyanate ester may be represented by formulae (1) to (4),

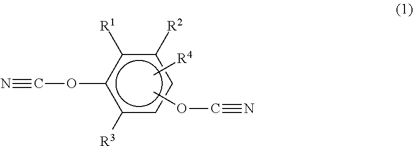

wherein R¹ to R⁴ are independently from each other hydrogen, C₁-C₁₀ alkyl, C₃-C₈ cycloalkyl, C₁-C₁₀ alkoxy, halogen, phenyl or phenoxy, and the alkyl, phenyl or phenoxy group are optionally partly or fully fluorinated;

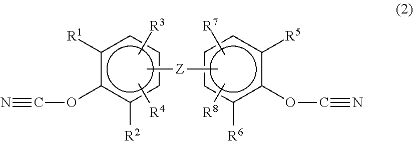

wherein R⁵ to R⁸ are defined as R¹ to R⁴ and Z is a chemical bond, —SO₂—, —CF₂—, —CH₂—, —CHF—, —CH(CH₃)—, —C(CH₃)₂—, —C(CF₃)₂—, C₁-C₁₀ alkyl, —O—, —NH—, —N═N—, —CH═CH—, —C(O)O—, —CH═N—, —CH═N—N═CH—, alkyloxyalkyl having a C₁-C₈ alkyl group, —S—, —Si(CH₃)₂—,

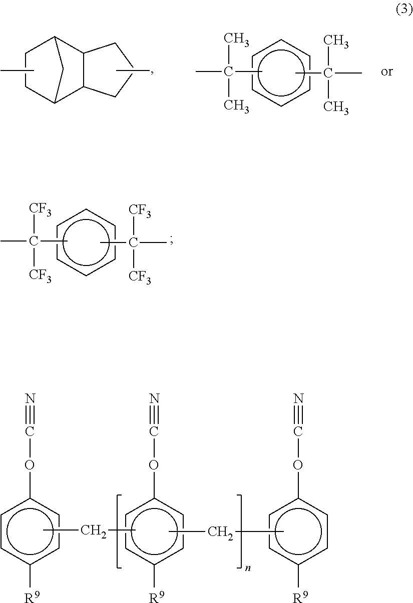

wherein R⁹ is hydrogen or C₁-C₁₀ alkyl and n is an integer from 0 to 20; and

N≡C—O—R¹⁰—O—C≡N (4)

wherein R¹⁰ is a divalent non-aromatic hydrocarbonyl having 3 to 100 carbon atoms, which can be substituted with one or more substituents selected from halogen, hydroxyl, acyl, and amino.

The polyfunctional monomeric cyanate suitable for use in the present invention may be represented by formulae (5) and (6):

N≡C—O—R¹⁰ (5)

wherein R¹⁰ is a divalent non-aromatic hydrocarbonyl having 3 to 100 carbon atoms, which can be substituted with one or more substituents selected from halogen, hydroxyl, acyl, and amino;

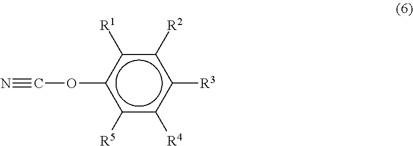

wherein R¹ to R⁴ are independently from each other hydrogen, C₁-C₁₀ alkyl, C₃-C₈ cycloalkyl, C₁-C₁₀ alkoxy, halogen, phenyl or phenoxy, and the alkyl, phenyl or phenoxy group are optionally partly or fully fluorinated.

Particular examples of the cyanate ester resin include, but are not limited to 4,4′-ethylidenebisphenylenecyanate, 2,2-bis(4-cyanatephenyl) propane, bis(4-cyanate-3,5-dimethylphenyl)methane. The cyanate ester resins can be used singly or in combination. In one preferred embodiment, the cyanate ester resin is 4,4′-ethylidenebisphenylenecyanate represented by the follow formula:

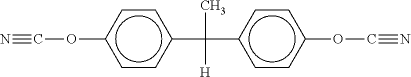

which is a cyanate ester monomer that has a bisphenol E based chemical structure.

The cyanate ester resins that can be used in present invention can be either in solid or liquid form. It is preferably in a liquid form at room temperature (25° C.) in order to provide good processability, however, it can also be solid as long as it can be mixed with other components of the sealant composition into a liquid state.

Among the commercially available cyanate ester resins suitable for use in the present invention, are for example bisphenol-A cyanate esters, hexafluorobisphenol-A cyanate esters, bisphenol-E cyanate esters, tetramethylbisphenol-F cyanate esters, bisphenol-M cyanate esters, phenol novolac cyanate esters, dicyclopentadienyl-bisphenol cyanate esters, novolac cyanate esters, such as those commercially available under the tradenames Primaset, like Primaset PT15, Primaset PT30, Primaset PT60, Primaset PTC-2500, BA-3000, DT-4000, DT-7000, Primaset BADCy, Primaset LECy, Primaset METHYLCy, Primaset BA200 from Lonza and AroCy, like AroCy B-10, AroCy F-10, and AroCy L-10 from Huntsman.

In the present invention, the cyanate ester resin provides the function of instant curing at elevated temperature, for example at 120° C., when curing with a proper catalyst. The cyanate ester resin used in the sealant composition is present in an amount of usually from 1 to 50%, and preferably from 2 to 30%, most preferably from 3 to 15%, based on the total weight of all components of the sealant composition. If the cyanate ester resin is present in an amount of less than 1% by weight, it cannot provide sufficiently fast curing speed. If the amount is higher than 50%, it will adversely increase the brittleness of cured product because of high crosslinking density of the structure of the cured cyanate ester resin.

### The Epoxy Resin

Although the cyanate ester resins can be homopolymerized in the presence of the latent curing agent under elevated temperature, it is preferred to use the combination of cyanate ester resin with an epoxy resin in the composition according to the present invention. Mixture of two different resins is preferred because firstly, by adding epoxy resin into the cyanate ester resin, the crosslinking density of the cured system decreases, and thus reduces the brittleness of the cured product; secondly, the cost of the sealant compositions will be reduced significantly because the cyanate ester resin is usually much more expensive than epoxy resins; and thirdly, it was also found that the overall adhesion strength is higher when using the mixture of cyanate ester and epoxy resin blend than using the cyanate ester resin alone. Therefore, an epoxy resin is also used in the sealant composition of the present invention.

Suitable epoxy resins for use in the present invention, although not limited, are preferably a difunctional or multifunctional epoxy resins. Examples include: bisphenol A-type epoxy resins, bisphenol F-type epoxy resins, bisphenol S-type epoxy resins, phenolic novolak type epoxy resins, cresol novolak type epoxy resins, bisphenol A novolak type epoxy resins, bisphenol F novolak type epoxy resins, alicyclic epoxy resins, fatty chain epoxy resins, glycidyl ester-type epoxy resins, glycidyl amine-type epoxy resins, hydantoin-type epoxy resins, isocyanuratetype epoxy resins and phenolic novolak type epoxy resins having a triphenolic methane skeleton; and in addition to these, also include naphthanlene type epoxy resins, diglycidyl-etherified products of difunctional phenols, diglycidyl-etherified products of difunctional alcohols, and halides and hydrogenated products thereof.

In one embodiment, the epoxy resin is selected from bisphenol A type epoxy resins, naphthanlene type epoxy resins, hydrogenated bisphenol A type epoxy resins, and combination thereof.

The epoxy resin can be either liquid or solid at room temperature, as long as it can be mixed with other components in the sealant composition into a liquid state.

In order to balance the curing speed, mechanical property and adhesion strength, the epoxy resin is present in an amount from 30 to 90%, preferably from 40 to 80%, and more preferably from 45 to 60% by weight based on the total weight of all components of the sealant composition.

### The Latent Curing Agent

As mentioned above, the curing process of the combination of cyanate ester resin and epoxy resin according to the present invention can be extremely fast according to the catalyst that is used. To ensure good viscosity stability at room temperature (pot life), usually a latent curing agent is used as the catalyst. As used herein, “latent curing agent” refers to a curing agent which is substantially non-reactive with the cyanate ester resin and epoxy resin at room temperature but reacts with cyanate ester resin and epoxy resin at an elevated temperature. It is preferred that the latent curing agent can start reacting with cyanate ester resin and epoxy resin at a temperature of less than 120° C.

Suitable latent curing agents for use in the present invention can be selected from latent curing agents commonly used in the art. Particularly, amine-based latent curing agents are preferred. Examples of the amine-based latent curing agents include but are not limited to well-known amine compounds having a latent property, and modified amines such as amine adducts. The modified amines include a core-shell type curing agent in which the surface of a core of an amine compound (or amine adducts) is surrounded with a shell of a modified product (the surface converted to adduct) of amine, and a master batch type curing agent in which the core-shell type curing agent is in a state of being mixed with an epoxy resin.

Examples of the amine compounds having a latent property include aromatic primary amines such as diaminodiphenylmethane and diaminodiphenylsulfone; imidazoles such as 2-heptadecylimidazole, 1-cyanoethyl-2-undecylimidazolium trimellitate, 2,4-diamino-6-[2-methylimidazolyl-(1)]-ethyl-S-triazine, 1-dodecyl-2-methyl-3-benzylimidazolium chloride, 2-phenylimidazolium isocyanurate and 2-phenyl-4-methyl-5-hydroxymethylimidazole; boron trifluoride-amine complex; dicyandiamide and derivatives thereof such as dicyandiamide, o-tolylbiguanide and a-2,5-methylbiguanide; organic acid hydrazides such as succinic acid dihydrazide and adipic acid dihydrazide; diaminomaleonitrile and derivatives thereof; and melamine derivatives such as melamine and diallylmelamine.

Amine adducts are the reaction products of an amine compound with an epoxy compound, an isocyanate compound and/or a urea compound.

The amine compound used for producing amine adducts may be a compound which has one or more active hydrogens in a molecule, capable of addition reaction with an epoxy group, an isocyanate group or a urea compound, and has at least one substituent selected from a primary amino group, a secondary amino group or a tertiary amino group in a molecule.

Examples of such amine compounds include but are not limited to diethylenetriamine, triethylenetetramine, n-propylamine, 2-hydroxyethylaminopropylamine, cyclohexylamine, dimethylaminopropylamine, dibutylaminopropylamine, dimethylaminoethylamine, diethylaminoethylamine and N-methyl piperazine; primary or secondary amines comprising a tertiary amino group in a molecule, including imidazole compounds such as 2-methylimidazole, 2-ethylimidazole, 2-ethyl-4-methylimidazole and 2-phenylimidazole; alcohols, phenols, thiols, carboxylic acids and hydrazides, which comprise a tertiary amino group in a molecule, such as 2-dimethylaminoethanol, 1-methyl-2-dimethylaminoethanol, 1-phenoxymethyl-2-dimethylaminoethanol, 2-diethylaminoethanol, 1-butoxymethyl-2-dimethylaminoethanol, 1-(2-hydroxy-3-phenoxypropyl)-2-methylimidazole, 1-(2-hydroxy-3-phenoxypropyl)-2-ethyl-4-methylimidazole, 1-(2-hydroxy-3-butoxypropyl)-2-methylimidazole, 1-(2-hydroxy-3-butoxypropyl)-2-ethyl-4-methylimidazole, 1-(2-hydroxy-3-phenoxypropyl)-2-phenylimidazoline, 1-(2-hydroxy-3-botoxypropyl)-2-phenylimidazoline, 2-(dimethylaminomethyl)phenol, 2,4,6-tris(dimethylaminomethyl)phenol, N-β-hydroxyethylmorpholine, 2-dimethylaminoethanethiol, 2-mercaptopyridine, 2-mercaptobenzoimidazole, 2-mercaptobenzothiazole, 4-mercaptopyridine, N,N-dimethylaminobenzoic acid, N,N-dimethylglycine, nicotinic acid, isonicotinic acid, picolinic acid, N,N-dimethylglycine hydrazide, N,N-dimethylpropionic acid hydrazide, nicotinic acid hydrazide and isonicotinic acid hydrazide.

Further, examples of the epoxy compounds which are used as a raw material for producing amine adducts include polyglycidyl ethers obtained by the reaction of polyhydric phenol such as bisphenol A, bisphenol F, catechol and resorcinol, or polyhydric alcohol such as glycerin and polyethylene glycol, with epichlorohydrin; glycidyl ether esters obtained by the reaction of hydroxycarboxylic acid such as p-hydroxybenzoic acid and β-hydroxynaphthoic acid with epichlorohydrin; polyglycidyl esters obtained by the reaction of polycarboxylic acid such as phthalic acid and terephthalic acid with epichlorohydrin; glycidyl amine compounds obtained from 4,4′-diaminodiphenylmethane and m-aminophenol; polyfunctional epoxy compounds such as epoxidized phenol novolac resin, epoxidized cresol novolac resin and epoxidized polyolefin; and monofunctional epoxy compounds such as butyl glycidyl ether, phenyl glycidyl ether and glycidyl methacrylate.

As the isocyanate compounds which are used as a raw material for producing amine adducts, monofunctional isocyanate compounds such as n-butyl isocyanate, isopropyl isocyanate, phenyl isocyanate and benzyl isocyanate; polyfunctional isocyanate compounds such as hexamethylene diisocyanate, tolylene diisocyanate, 1,5-naphthalene diisocyanate, diphenylmethane-4,4′-diisocyanate, isophorone diisocyanate, xylylene diisocyanate, p-phenylene diisocyanate, 1,3,6-hexamethylene triisocyanate and bicycloheptane triisocyanate; and compounds containing an isocyanate group at their ends, which are obtained by the reaction of the above polyfunctional isocyanate compounds with active hydrogen compounds, can be used, and examples of such compounds include addition reaction products having an isocyanate group at their ends which are obtained by the reaction of tolylene diisocyanate with trimethylolpropane.

Examples of the urea compounds, which are used as a raw material for producing amine adducts, include urea, urea phosphate, urea oxalate, urea acetate, diacetyl urea, dibenzoylurea, and trimethylurea.

Further, the core-shell type curing agent is obtained by further treating the surface of an amine compound (or amine adducts) with acid compounds such as a carboxylic acid compound and a sulfonic acid compound, isocyanate compounds or epoxy compounds to form a shell of a modified product (adducts, etc.) onto the surface. Further, the master batch type curing agent is the core-shell type curing agent in a state of being mixed with an epoxy resin.

In one embodiment, the latent curing agent is selected from aromatic primary amines, imidazoles, boron trifluoride-amine complex, dicyandiamide and derivatives thereof, organic acid hydrazides, diaminomaleonitrile and derivatives thereof, melamine and derivatives thereof, amine-epoxy adducts, amine-isocyanate adducts, amine-urea adducts and combination thereof.

Examples of commercially available latent curing agents include, but are not limited to Adeka Hardener EH-5011S (imidazole type), Adeka Hardener EH-4357S (modified amine type), Adeka Hardener EH-4357PK (modified amine type), Adeka Hardener EH-4380S (special hybrid type), Adeka Hardener EH-5001P (special modified type), Ancamine 2014FG/2014AS (modified polyamine), Ancamine 2441(modified polyamine), Ancamine2337s (modified amine type), Fujicure FXR-1081(modified amine type), Fujicure FXR-1020 (modified amine type), Sunmide LH-210 (modified imidazole type), Sunmide LH-2102 (modified imidazole type), Sunmide LH-2100 (modified imidazole type), Ajicure PN-23 (modified imidazole type), Ajicure PN-23J (modified imidazole type), Ajicure PN-31 (modified imidazole type), Ajicure PN-31J (modified imidazole type), Novacure HX-3722 (master batch type), Novacure HX-3742 (master batch type), Novacure HX-3613 (masterbatch type), and the like.

Latent curing agents having a melting temperature from 50 to 150° C., particularly having a melting temperature from 60 to 120° C. are more preferred. Those having a melting temperature lower than 50° C. have the problem of poor viscosity stability, while those having a melting temperature higher than 150° C. need longer time of thermal curing, which causes a higher tendency of liquid crystal contamination.

The amount of the latent curing agent contained in the composition may be appropriately selected depending on the type of the latent curing agent and the epoxy amount in the epoxy resin contained in the sealant composition. Normally, the latent curing agent used in the sealant composition is present in an amount from 1 to 40%, and preferably from 2 to 30%, based on the total weight of all components of the sealant composition.

### The Gelling Agent

In the thermally curing process for the sealant composition according to the present invention, the sealant viscosity drop upon temperature increase, and this is the root cause for the liquid crystal cell-broken and contamination. The viscosity drop of the sealant composition is not only due to viscosity change of the resins at elevated temperature, but is also due to the melting behavior of the latent curing agent at its melting point. The applicant has surprisingly found that the addition of a gelling agent can compensate the viscosity drop of the sealant composition under an elevated temperature. By using gelling agent the distortion or breaking of sealant can be prevented and to provide the best performance for the sealing of liquid crystal.

The term “gelling agent” as used herein refers to a compound capable of increasing the viscosity of the sealant composition at elevated temperature, and thus contributes to rendering the sealant composition to become a gel or semi-gel (semi-solid).

The gelling agent useful in the present invention comprises one or more core particles consisting of a resin having a glass transition temperature of lower than −10° C., and one or more shell layers consisting of a resin having a glass transition temperature from 50 to 150° C. formed on the surface of the core particle.

According to the present invention, the resin having a glass transition temperature of lower than −10° C. can be a homopolymer or copolymer. Suitable monomers for use in the core-shell type gelling agent are selected from ethyl acrylate, propyl acrylate, n-butyl acrylate, cyclohexyl acrylate, 2-ethylhexyl acrylate, ethyl methacrylate, n-butyl methacrylate, and combination thereof. Preferred is n-butyl acrylate.

According to the present invention, the resin having a glass transition temperature of 50-150° C. suitable for use in the core-shell type gelling agent can be a homopolymer or copolymer. Suitable monomers for use herein are selected from methacrylic acid, isopropyl methacrylate, tert-butyl methacrylate, cyclohexyl methacrylate, phenyl methacrylate, methyl methacrylate, styrene, 4-chloro styrene, 2-ethyl styrene, acrylonitrile, vinyl chloride, and combination thereof. Preferred are methyl methacrylate and a copolymer of methyl methacrylate and methacrylic acid.

The particle size of the gelling agent is generally in the range from 0.01 μm to 5 μm, preferably from 0.1 μm to 2 μm.

The method for manufacturing the gelling agent in the form of fine particle is not particularly limited, and can be exemplified by the following method: forming core particles by polymerizing the resin having a glass transition temperature of lower than −10° C. using emulsion polymerization, and then adding the resin having a glass transition temperature from 50 to 150° C. as the monomers for the shell layer to polymerize on the surface of the core particles and thus obtaining the shell layer.

Examples of gelling agents of core-shell structure are such as methyl methacrylate-butyl methacrylate copolymers, ethyl methacrylate-butyl methacrylate copolymers, methyl methacrylate-propyl methacrylate copolymers, and butylacrylate-methacrylic acid-methyl methacrylate copolymers.

During the thermal curing, the copolymer particles of the gelling agent fuse and swell on its surface layer with the resin according to the present invention. Accordingly, the gelling agent useful in the sealant composition can be semi-gelling when heating at the temperature from 50 to 150° C., and the viscosity drop of the sealant composition is compensated. Furthermore, such gelling agent can relieve internal stress, and thus provide enhancement of sealant adhesion strength of the sealant composition.

Suitable gelling agent of core-shell structure are commercially available, for example from Ganz Chemical Co., Ltd., under the trade names of such as F301, F303, F320, F325, F340, F351S, and F351.

The gelling agent used in the sealant composition is present in an amount from 1 to 30%, and preferably from 5 to 25%, based on the total weight of all components of the sealant composition. If the amount is less than 1% by weight, it will be not sufficient to provide gelling properties. On the other hand, if it is more than 30%, it will result in excessive high viscosity of the sealant composition which is difficult to be dispensed.

### Other Components

The sealant composition may further comprise one or more additives, resin components and the like to improve or modify properties of the sealant composition, such as flowability, dispensing or printing property, storage stability, curing property and physical property after curing.

The components that may be contained in the sealant composition as needed include, but are not limited to, for example, organic or inorganic filler, thixotropic agent, silane coupling agent, diluent, modifier, coloring agent such as pigment and dye, surfactant, preservative-stabilizer, plasticizer, lubricant, defoamer, leveling agent and the like. In particular, the sealant composition preferably comprises an additive selected from the group consisting of inorganic or organic filler, a thixotropic agent, a silane coupling agent, and combination thereof.

Suitable fillers, which can be optionally used in the present invention includes, but are not limited to, inorganic fillers such as silica, diatomaceous earth, alumina, zinc oxide, iron oxide, magnesium oxide, tin oxide, titanium oxide, magnesium hydroxide, aluminium hydroxide, magnesium carbonate, barium sulphate, gypsum, calcium silicate, talc, glass bead, sericite activated white earth, bentonite, aluminum nitride, silicon nitride, and the like; organic fillers, such as polymethyl methacrylate, polyethyl methacrylate, polypropyl methacrylate, polybutyl methacrylate, poly acrylonitrile, polystyrene, polybutadiene, polypentadiene, polyisoprene, polyisopropylene, and the like. The filler may be used alone or in combination thereof.

Suitable thixotropic agents, which can be optionally used in the present invention includes, but are not limited to, talc, fume silica, superfine surface-treated calcium carbonate, fine particle alumina, plate-like alumina; layered compound such as montmorillonite, spicular compound such as aluminium borate whisker, and the like. Talc, fume silica and fine alumina are preferred thixotropic agents.

Suitable silane coupling agents, which can be optionally used in the present invention includes, but is not limited to, γ-aminopropyltriethoxysilane, γ-mercaptopropyltrimethoxysilane, γ-methacryloxypropyltrimethoxysilane, γ-glycidoxypropyltrimethoxylsilane, and the like.

The sealant composition according to the present invention is prepared by conventional methods in the art. For example, the sealant composition according to the present invention may be obtained by mixing the aforementioned each component by means of, for example, a mixer such as a stirrer having stirring blades and a three roll mill. The composition is liquid at ambient atmosphere with a viscosity of 250-450 Pa·s (at 25° C.) at 15 s⁻¹ shear rate, which allows its good dispensing property.

The combination of the cyanate ester resin, the epoxy resin, and the latent curing agent in the sealant composition provides a fast gelling time upon heating, which gels at 120° C. less than 20 seconds, and preferably less than 15 seconds.

The curing condition for the sealant composition is that the heating temperature is within a range from 80 to 130° C., preferably from100 to 120° C. for 30 mins or up to 3 hours, and typically 1 hour. After curing, a cured product is obtained from the sealant composition according to the present application.

Therefore, the sealant composition according to the present invention is suitable for the manufacturing of liquid crystal display devices, particularly for sealing liquid crystal by means of liquid crystal one-drop-filling process, and does not require ultraviolet irradiation process.

Furthermore, the present invention also relates to a method for manufacturing a liquid crystal display having a liquid crystal layer between a first substrate and a second substrate, by means of a liquid crystal one-drop-filling process. The method comprises the steps:

(a) applying the sealant composition as described in the present invention on a sealing region at periphery of a surface of the first substrate;

(b) dropping liquid crystal on a central area encircled by the sealing region of the surface of the first substrate;

(c) overlaying the second substrate on the first substrate; and

(d) performing fixation and curing by heating the sealant composition at from 80 to 130° C. for 30 min to 3 h.

The first substrate and the second substrate used in the present invention are preferably transparent glass substrates. Generally, transparent electrodes, active matrix elements (such as TFT), alignment film(s), a color filter and the like are formed on at least one of the opposed faces of the two substrates. These elements may be modified according to the type of the LCD. The manufacturing method according to the present invention can be used for any type of the LCD.

In the step (a), the sealant composition is applied on the periphery portion of the surface of the first substrate so as to lap around the substrate circumference in a frame shape. The portion where the sealant composition is applied in a frame shape is referred as a sealing region. The sealant composition can be applied by a known method such as screen printing and dispensing.

In the step (b), the liquid crystal is then dropped onto the center region surrounded by the sealing region in the frame shape on the surface of the first substrate. This step is preferably conducted under reduced pressure.

In the step (c), said second substrate is placed over said first substrate, and in the step (d), heating the sealant composition allows it to achieve the fixation and curing strength, whereby the two substrates are finally adhered. The thermal curing in the step (d) is generally performed at a temperature from 80 to 130° C., and preferably from 100 to 120° C., with the heating time of 30 minutes up to 3 hours, typically being 1 hour.

By the aforementioned method, the major part of the LCD panel is obtained.

The sealant composition used in the present invention may be also applied for other applications, where fast assembling is necessary, for example, manufacturing cameras and other optical products. For example manufacturing CDs and electronic circuit boards. Use in watch-making industry or in mobile phone keypad assembly or in manufacturing in optoelectronic information industry such as manufacturing of the polarized components.

The present invention may be better understood with reference to the following examples.

### EXAMPLES

The components used in the sealant compositions of the present invention and the comparative examples are set forth in Table 1.

TABLE 1
The formulation of the sealant compositions
(the units of values are represented by parts by weight)

| Com- | | Inventive Example | | | Comparative Example | | |
|---|---|---|---|---|---|---|---|
| ponents | Type | 1 | 2 | 3 | 1 | 2 | 3 |
| Cyanate | Primaset | 6.06 | 3.17 | 6.83 | 3.17 | | |
| ester | LECY¹ | | | | | | |
| resin | | | | | | | |
| Epoxy | 850S² | 5.09 | 5.33 | 47.36 | 5.33 | 51.90 | 45.46 |
| resin | HP4700³ | | | | | 12.36 | 10.82 |
| | YX8034⁴ | 35.60 | 37.30 | | 37.30 | | |
| | HP4032D⁵ | 12.72 | 13.32 | | 13.32 | | |
| Latent | 2014AS⁶ | 3.03 | 1.59 | 2.28 | 1.59 | | |
| curing | EH-4357S⁷ | 25.30 | 26.50 | 27.32 | 26.50 | | |
| agent | PN-23J⁸ | | | | | 13.49 | |
| | VDH-J⁹ | | | | | | 24.24 |
| Gelling | F-351¹⁰ | 11.44 | 11.99 | | | 21.01 | 18.40 |
| agent | F340M¹¹ | | | 15.48 | | | |
| Silica | SO-E2¹² | | | | 11.99 | | |
| filler | | | | | | | |
| Silane | γ-glycidoxy- | 0.76 | 0.80 | 0.73 | 0.80 | 1.24 | 1.08 |
| coupling | propyl | | | | | | |
| agent | trimethoxyl- | | | | | | |
| | silane | | | | | | |

¹Cyanate ester resin represented by the formula below: Primaset LECY, manufactured by Lonza Ltd.

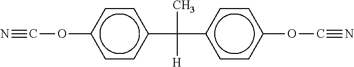

²Liquid epoxy resin: EPICLON 850S, Bisphenol A type epoxy, manufactured by Dainippon Ink & Chemicals, Inc.
³Solid epoxy resin: EPICLON HP4700, Naphthalene type tetra-functional epoxy, manufactured by Dainippon Ink & Chemicals, Inc.
⁴Liquid epoxy resin: YX8034, Hydrogenated bisphenol A type epoxy, manufactured by Japanese epoxy resin Co. Ltd.
⁵Liquid epoxy resin: EPICLON HP4032D, Naphthalene type di-functional epoxy, manufactured by Dainippon Ink & Chemicals, Inc.
⁶Latent curing agent: Ancamine 2014AS, manufactured by Air Products and Chemicals, Inc., further grounded to fine powder.
⁷Latent curing agent: EH-4357S, modified amine, manufactured by ADEKA Corporation, further grounded to fine powder.
⁸Latent curing agent: PN-23J, modified imidazole type, manufactured by Ajinomoto Fine-Techno Co., Inc.
⁹Latent curing agent: VDH-J, Hydrazide type, manufactured by Ajinomoto Fine-Techno Co., Inc.
¹⁰Gelling agent: ZEFIAC F351, butylacrylate-methacrylic acid-methylmethacrylate copolymer, average particle size 0.3 μm, manufactured by Ganz Chemical Co., Ltd.
¹¹Gelling agent: ZEFIAC F340M, methacrylates copolymers, average particle size 1 μm, manufactured by Ganz Chemical Co., Ltd.
¹²Silica filler: SO-E2, average particle size 0.5 μm, manufactured by Admatechs Co., Ltd.

The materials shown in Table 1 were sufficiently mixed by a stirrer followed by a three roll miller to give each composition, and then the obtained compositions were tested respectively using testing methods as below:

### Testing Methods

### Viscosity and Viscosity Stability

The initial viscosity of the sealant composition at 25° C. was measured by a rheometer (TA, AR2000 ex) at a shear rate of 15 s⁻¹. An opaque polyethylene jar was charged with 10 grams of the sealant composition and tightly sealed, then after storage at 25° C. for 2 days, the viscosity value at a shear rate of 15 s⁻¹ was measured again. The initial viscosity and viscosity increase after 2 days (versus initial viscosity) are shown in Table 2. The viscosity increasing ratio of less than 25% indicates good storage stability, while a result of more than 25% shows poor storage stability.

### Gelling Time on Hot Plate

A glass slide was put on a hot plate (preset at 120° C.) for 5 minutes, until the glass slide reached the temperature of 120° C. 1 mL of the sealant composition was then injected on the surface of glass slide, and time record was started. The gelling time is defined by the time when the whole surface gelled. The gelling of the surface is determined by the following method: touching the surface of the sealant product with a metal tweezer for 1 second, lifting the tweezer, and checking whether there is any sealant residue on the tweezer. If the surface is tack-free, in other word, no sealant residue can be found on the tweezer, the sealant is defined as completely gelling.

### Sealant Strength and Adhesion Reliability After Storage Under Elevated Temperature and High Humidity

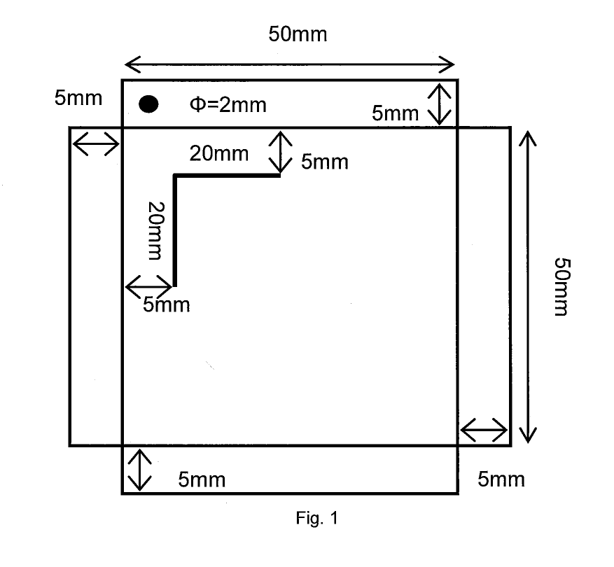

1 part by weight of 5 μm spacer was added to the sealant composition, which was then dispensed (using Asymtek) on an ITO (Indium Tin Oxide) glass of 50 mm×50 mm×0.7 mm to form two crossed line having a length of 20 mm and a diameter of about 0.7 mm respectively (as shown in FIG. 1). A similar counter ITO glass was crosswisely superposed to join them and fixed under loading, then the specimen was subject to heat-treatment in an oven preset at 120° C. for 60 minutes. The resultant specimen was tested by fixing the top glass in the mould, and pressing on the bottom glass by a metal column (with a diameter of 2 mm, as shown in FIG. 1) at a pressing rate of 1.27 mm/s (using Instron tester). The largest press strength value was recorded and the line width divided by the press strength was referred to as sealant strength (N/mm). The value that is higher than 10 N/mm is considered to be good adhesion, in the range of 6-10 N/mm considered to be fair, while less than 6 N/mm considered to be poor.

The adhesion specimen was produced in the same manner as in the above-described, and stored in an elevated temperature and high humidity chamber at a temperature of 60° C. and a humidity of 90% for 5 days (120 hours), then the adhesion strength was tested using the same test method as described above. The maintenance of the sealant strength relative to the sealant strength before the elevated temperature and high humidity storage of more than 30% represents good adhesion reliability after high-temperature and high humidity storage. In contrast, the maintenance of less than 30% represents poor adhesion reliability after elevated temperature and high humidity storage.

### Liquid Crystal Contamination by NI Point Change

When heated up, liquid crystal will experience a transition from nematic phase to isotropic phase, the transition temperature is called NI point. When liquid crystal is contaminated, its NI point will be lower than that of pure liquid crystal. The NI point change is defined as the subtraction of pure liquid crystal NI point and contaminated liquid crystal NI point, and is used as a way to characterize the liquid crystal contamination performance of a sealant composition.

In the present invention, NI point was measured by Differential Scanning Calorimetry (DSC). 0.05 g resin was firstly added into a small bottle, then 0.45 g liquid crystal was dropped into that bottle. The bottle having mixture was put into 120° C. oven for 1 hour to mimic the real curing process in one-drop-filling process. Then 8 mg contaminated LC was sealed in a DSC pan, followed by a ramping up speed of 5° C./min, from 30° C. to 150° C., using DSC Q2000. 0.45 g pure liquid crystal was added into a bottle and put into 120° C. oven for 1 hour, followed by the same DSC test as the contaminated LC. The endothermic peak temperature during the heating curve was recorded as NI point of the contaminated or pure liquid crystal. The NI point changes of the contaminated liquid crystals for each sealant composition are shown in Table 2.

### The Evaluation of Liquid Crystal Sealing Performance

1 part by weight of 5 μm spacer was added to the sealant composition. Then 2 mg obtained sealant composition was dispensed (using Asymtek) in a rectangular shape at periphery of the surface of a glass substrate (20 mm×70 mm). Later, 7 mg liquid crystal was dropped on the central area encircled by the sealing region and degassed in vacuum, followed by overlaying a second glass substrate on the first substrate. After the attachment of two glass substrates, the vacuum was released to obtain the specimen. The specimen was then put into an oven preset at 120° C. for 60 minutes, in order to complete a mimic LCD cell of the one-drop-filling process. The obtained mimic LCD cell was inspected under a microscope to verify the sealing performance, such as the sealing shape maintenance and liquid crystal leakage. The sealing performance was recorded as “good” if the sealing shape was well kept and no liquid crystal penetration or leakage, and recorded as “fair” if no liquid crystal leakage but some liquid crystal penetration, while it was recorded as “poor” if there was liquid crystal leakage.

All of the test results are shown in Table 2.

TABLE 2
Testing results

| | | Inventive | | | Comparative | | |
|---|---|---|---|---|---|---|---|
| | | Example | | | example | | |
| Testing items | | 1 | 2 | 3 | 1 | 2 | 3 |
| Viscosity | Pa · s at 15 s⁻¹ | 318.6 | 414.1 | 352.7 | 310.2 | 258.1 | 294.8 |
| Viscosity | 25° C. for 2 days | Good | Good | Good | Good | Poor | Good |
| stability | | | | | | | |
| Gelling time on | at 120° C., | 11 | 12 | 10 | 20 | 40 | 300 |
| hot plate | seconds | | | | | | |
| Sealant strength | N/mm | 11.7 | 11.6 | 12.5 | 8.7 | 13.4 | 18.6 |
| Adhesion | after 60° C./90% | Good | Good | Good | Good | Good | Good |
| reliability | humidity for 120 | | | | | | |
| | hours, N/mm | | | | | | |
| NI point change | ° C. | 0.98 | 1.39 | 1.58 | 1.74 | 4.2 | 5.4 |
| Liquid crystal | | Good | Good | Good | Fair | Poor | Poor |
| sealing | | | | | | | |
| performance | | | | | | | |

As shown from the results of Table 2, all the inventive examples 1 to 3 exhibited viscosity in the range of 250 to 450 Pa·s, as well as good viscosity stability at room temperature. Also they exhibited very fast gelling time on hot plate at 120° C. (within 20 seconds), which were much faster than any of comparative examples 1 to 3. The fast gelling time can provide the fast fixing of sealant shape and avoid the contamination from resin component to liquid crystal. This has been demonstrated by the data of NI point change. The smaller NI point change in all of the inventive examples 1 to 3 indicated less contamination to the liquid crystal from sealant compositions, while the much higher NI point change in comparative examples 2 to 3 indicated more contamination from the sealant compositions.

Furthermore, the fast gelling time can ensure the sealant shape integrity during cure process, resulting in good sealing condition without liquid crystal penetration or leakage, as shown in inventive examples 1 to 3. On the other hand, the comparative examples 1 to 3 with slower gelling time demonstrated fair or poor liquid crystal sealing performance.

Comparing the inventive example 2 with the comparative example 1, it can be seen that the slower gelling time and poorer liquid crystal sealing performance of comparative example 1 was caused by the replacement of core-shell type (meth)acrylic copolymer with silica filler, which demonstrates that the using of core-shell type (meth)acrylic copolymers as gelling agent is beneficial for faster gelling time and better sealing performance due to the effect of compensating the viscosity decrease of the sealant composition at elevated temperature.

As an important requirement to ensure reliability of LCD panel, all of the adhesion strength for inventive examples 1 to 3 were good (>10 N/mm). The adhesion after elevated temperature and high humidity also maintained well. The comparative examples 2 and 3 did not show weakness in adhesion and adhesion reliability, but had issues of slower gelling speed and poor liquid crystal sealing performance. It was also noticed from comparative example 1 that the core-shell type (meth)acrylic copolymers contributed to higher adhesion strength of the cured product of the sealant composition than the silica filler.

All above results indicated that the compositions according to the present invention have fast curing/gelling speed with good viscosity stability, and the cured products have excellent adhesion strength and high reliability, which enable their use suitable for sealing liquid crystal by one-drop-filling method, which does not require ultraviolet irradiation process.

Furthermore, those of ordinary skill in the art will appreciate that the foregoing description is by way of example only, and is not intended to limit the invention so further described in such appended claims.

What is claimed is:

1. A thermally curable sealant composition, comprising:
(a) from 1 to 50% by weight of a cyanate ester resin,
(b) from 30 to 90% by weight of an epoxy resin,
(c) from 1 to 40% by weight of a latent curing agent, and
(d) from 1 to 30% by weight of a gelling agent, which comprises one or more core particles consisting of a resin having a glass transition temperature of lower than −10° C., and one or more shell layers consisting of a resin having a glass transition temperature of 50-150° C. formed on the surface of the core particle,
in which the weight percentages are based on the total weight of all components of the sealant composition.

2. The sealant composition according to claim 1, wherein the cyanate ester resin is selected from a polyfunctional monomeric cyanate ester, a polyfunctional polymeric cyanate ester, and combinations thereof.

3. The sealant composition according to claim 2, wherein the polyfunctional monomeric cyanate ester is represented by formulae (1) to (4), 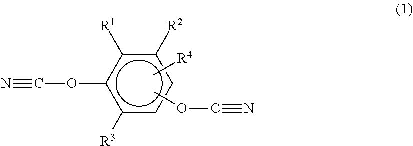
wherein R¹ to R⁴ are independently from each other hydrogen, C₁-C₁₀ alkyl, C₃-C₈ cycloalkyl, C₁-C₁₀ alkoxy, halogen, phenyl or phenoxy, and the alkyl, phenyl or phenoxy group are optionally partly or fully fluorinated; 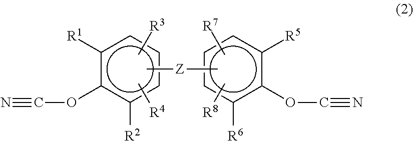
wherein R⁵ to R⁸ are defined as R¹ to R⁴ and Z is a chemical bond, SO₂, CF₂, CH₂, CHF, CH(CH₃), C(CH₃)₂, C(CF₃)₂, C₁-C₁₀ alkyl, O, NH, N═N, CH═CH, COO, CH═N, CH═N—N═CH, alkyloxyalkyl having a C₁-C₈ alkyl group, S, Si(CH₃)₂, 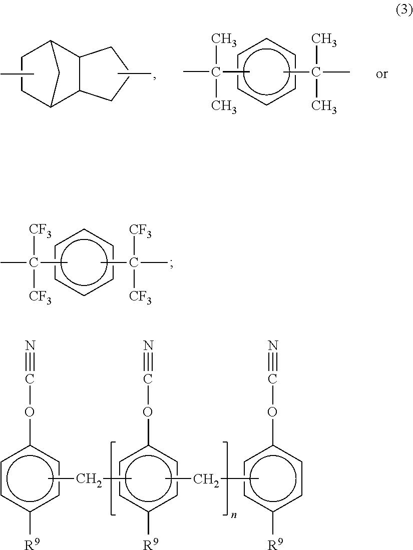
wherein R⁹ is hydrogen or C₁-C₁₀ alkyl and n is an integer from 0 to 20;
N≡C—O—R¹⁰—O—C≡N (4)
wherein R¹⁰ is a divalent non-aromatic hydrocarbonyl having 3 to 100 carbon atoms, which can be substituted with one or more substituents selected from halogen, hydroxyl, acyl, and amino.

4. The sealant composition according to claim 2, wherein the polyfunctional monomeric cyanate is represented by formulae (5) and (6):
N≡C—O—R¹⁰ (5)
wherein R¹⁰ is a divalent non-aromatic hydrocarbonyl having 3 to 100 carbon atoms, which can be substituted with one or more substituents selected from halogen, hydroxyl, acyl, and amino; 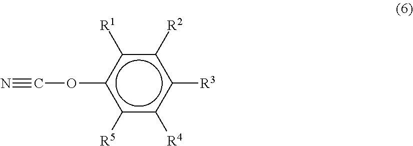
wherein R¹ to R⁴ are independently from each other hydrogen, C₁-C₁₀ alkyl, C₃-C₈ cycloalkyl, C₁-C₁₀ alkoxy, halogen, phenyl or phenoxy, and the alkyl, phenyl or phenoxy group are optionally partly or fully fluorinated.

5. The sealant composition according to claim 1, wherein the cyanate ester resin is selected from 4,4′-ethylidenebisphenylenecyanate, 2,2-bis(4-cyanatephenyl) propane, bis(4-cyanate-3,5-dimethylphenyl)methane, and combination thereof.

6. The sealant composition according to claim 1, wherein the cyanate ester resin has a cyanate ester equivalent weight from 50 to 500.

7. The sealant composition according to claim 1, wherein the cyanate ester resin has a weight average molecular weight from 150 to 2000.

8. The sealant composition according to claim 1, wherein the cyanate ester resin is present in an amount from 2 to 30% by weight based on the total weight of all components of the sealant composition.

9. The sealant composition according to claim 1, wherein the epoxy resin is selected from bisphenol A type epoxy resins, bisphenol F type epoxy resins, bisphenol S type epoxy resins, phenolic novolak type epoxy resins, cresol novolak type epoxy resins, bisphenol A novolak type epoxy resins, bisphenol F novolak type epoxy resins, alicyclic epoxy resins, fatty chain epoxy resins, glycidyl ester type epoxy resins, glycidyl amine type epoxy resins, hydantoin type epoxy resins, isocyanurate type epoxy resins, phenolic novolak type epoxy resins, naphthanlene type epoxy resins, diglycidyl-etherified products of difunctional phenols, diglycidyl-etherified products of difunctional alcohols, halides and hydrogenated products thereof; and combination thereof.

10. The sealant composition according to claim 1, wherein the epoxy resin is selected from bisphenol A type epoxy resins, naphthanlene type epoxy resins, hydrogenated bisphenol A type epoxy resins, and combination thereof.

11. The sealant composition according to claim 1, wherein the epoxy resin is present in an amount from 40 to 80% by weight based on the total weight of all components of the sealant composition.

12. The sealant composition according to claim 1, wherein the latent curing agent is selected from aromatic primary amines, imidazoles, boron trifluoride-amine complex, dicyandiamide and derivatives thereof, organic acid hydrazides, diaminomaleonitrile and derivatives thereof, melamine and derivatives thereof, amine-epoxy adducts, amine-isocyanate adducts, amine-urea adducts and combination thereof.

13. The sealant composition according to claim 1, wherein the latent curing agent has a melting temperature from 50 to 150° C.

14. The sealant composition according to claim 1, wherein the latent curing agent is present in an amount from 2 to 30% by weight based on the total weight of all components of the sealant composition.

15. The sealant composition according to claim 1, wherein the resin having a glass transition temperature of lower than −10° C. is the homopolymer or copolymer of the monomers selected from ethyl acrylate, propyl acrylate, n-butyl acrylate, cyclohexyl acrylate, 2-ethylhexyl acrylate, ethyl methacrylate, n-butyl methacrylate, and combination thereof, preferably n-butyl acrylate.

16. The sealant composition according to claim 14, wherein the resin having a glass transition temperature of 50-150° C. is the copolymer of the monomers selected from methacrylic acid, isopropyl methacrylate, tert-butyl methacrylate, cyclohexyl methacrylate, phenyl methacrylate, methyl methacrylate, styrene, 4-chloro styrene, 2-ethyl styrene, acrylonitrile, vinyl chloride, and combination thereof, preferably methyl methacrylate and a copolymer of methyl methacrylate and methacrylic acid.

17. The sealant composition according to claim 14, wherein the gelling agent is semi-gelling at the temperature from 50 to 150° C.

18. The sealant composition according to claim 1, wherein the gelling agent is present in an amount from 5 to 25% by weight based on the total weight of all components of the sealant composition.

19. The sealant composition according to claim 1, which further comprises a filler selected from silica, diatomaceous earth, alumina, zinc oxide, iron oxide, magnesium oxide, tin oxide, titanium oxide, magnesium hydroxide, aluminium hydroxide, magnesium carbonate, barium sulphate, gypsum, calcium silicate, talc, glass bead, sericite activated white earth, bentonite, aluminum nitride, silicon nitride, polymethyl methacrylate, polyethyl methacrylate, polypropyl methacrylate, polybutyl methacrylate, butylacrylate-methacrylic acid-methyl methacrylate copolymer, polyacrylonitrile, polystyrene, polybutadiene, polypentadiene, polyisoprene, polyisopropylene, and combination thereof.

20. The sealant composition according to claim 1, which further comprises a silane coupling selected from γ-aminopropyltriethoxysilane, γ-mercaptopropyltrimethoxysilane, γ-methacryloxypropyltrimethoxysilane, γ-glycidoxypropyltrimethoxylsilane, and combination thereof.

21. The sealant composition according to claim 1, which has a viscosity of 250-450 Pa·s at 25° C. at a shear rate of 15 s⁻¹.

22. A cured product of the sealant composition according to claim 1.

23. A method for manufacturing a liquid crystal display having a liquid crystal layer between a first substrate and a second substrate, the method comprising the steps:
(a) applying the sealant composition according to claim 1 on a sealing region at periphery of a surface of the first substrate;
(b) dropping liquid crystal on a central area encircled by the sealing region of the surface of the first substrate and obtaining a liquid crystal layer;
(c) overlaying the second substrate on the first substrate; and
(d) performing fixation and curing by heating the sealant composition at from 80 to 130° C. for 30 min to 3 h.
